(19) United States
(12) Patent Application Publication
(10) Pub. No.: US 2025/0212170 A1
(43) Pub. Date: Jun. 26, 2025

(54) FINE TIMING MEASUREMENT EXCHANGES USING BANDWIDTH CONTROL

(71) Applicant: Cisco Technology, Inc., San Jose, CA (US)

(72) Inventors: Jerome HENRY, Pittsboro, NC (US); Indermeet S. GANDHI, San Jose, CA (US); Robert E. BARTON, Richmond (CA); Matthew A. SILVERMAN, Shaker Heights, OH (US); Laurent A. PIERRUGUES, San Jose, CA (US)

(21) Appl. No.: 18/597,721

(22) Filed: Mar. 6, 2024

Related U.S. Application Data
(60) Provisional application No. 63/614,526, filed on Dec. 23, 2023.

(51) Int. Cl. H04W 64/00

(52) U.S. Cl. CPC H04W 64/006

(57) ABSTRACT

The present disclosure describes wireless networks (e.g., WiFi networks) that use machine learning to determine FTM ranging parameters for FTM exchanges. An apparatus includes one or more memories and one or more processors communicatively coupled to the one or more memories. A combination of the one or more processors predicts a ranging accuracy for a device by applying a machine learning model to a request from the device to perform an FTM exchange, determines, based on the ranging accuracy, an FTM ranging parameter for the FTM exchange, and performs the FTM exchange based on the FTM ranging parameter to determine a location of the device.

### CROSS-REFERENCE TO RELATED APPLICATIONS

This application claims benefit of co-pending U.S. provisional patent application Ser. No. 63/614,526 filed Dec. 23, 2023. The aforementioned related patent application is herein incorporated by reference in its entirety.

### TECHNICAL FIELD

Embodiments presented in this disclosure generally relate to wireless communications. More specifically, embodiments disclosed herein relate to using artificial intelligence to control ranging parameters for fine timing measurement (FTM) exchanges.

### BACKGROUND

Access points in wireless networks (e.g., wireless fidelity (WiFi) networks) may perform FTM exchanges with other components in the networks (e.g., other access points and other devices) to determine the locations of these other components. As wireless networks grow denser (e.g., at office or retail spaces, or at large venues), the number of devices performing FTM exchanges with the access points increases, which may increase congestion. If the access points reject or override the FTM requests from the devices to reduce congestion, however, the accuracy of the FTM exchanges decreases.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIGS. 1A and 1B illustrate an example system.

FIG. 2 illustrates an example operation performed by the system of FIG. 1A.

FIG. 3 illustrates an example operation performed by the system of FIG. 1A.

FIG. 4 illustrates an example operation performed by the system of FIG. 1A.

FIG. 5 illustrates an example operation performed by the system of FIG. 1A.

FIG. 6 illustrates an example operation performed by the system of FIG. 1A.

FIG. 7 illustrates an example operation performed by the system of FIG. 1A.

FIG. 8 illustrates an example operation performed by the system of FIG. 1A.

FIG. 9 illustrates an example operation performed by the system of FIG. 1A.

FIG. 10 is a flowchart of an example method performed by the system of FIG. 1A.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

The present disclosure describes wireless networks (e.g., WiFi networks) that use artificial intelligence to determine FTM ranging parameters for FTM exchanges. According to an embodiment, an apparatus includes one or more memories and one or more processors communicatively coupled to the one or more memories. A combination of the one or more processors predicts a ranging accuracy for a device by applying a machine learning model to a request from the device to perform an FTM exchange, determines, based on the ranging accuracy, an FTM ranging parameter for the FTM exchange, and performs the FTM exchange based on the FTM ranging parameter to determine a location of the device.

According to another embodiment, a method includes predicting a ranging accuracy for a device by applying a machine learning model to a request from the device to perform an FTM exchange, determining, based on the ranging accuracy, an FTM ranging parameter for the FTM exchange, and perform the FTM exchange based on the FTM ranging parameter to determine a location of the device.

According to another embodiment, a system includes a device and an access point. The device communicates a request to perform an FTM exchange. The access point applies a machine learning model to the request from the device to predict a ranging accuracy for the device and determines at least one of (i) a bandwidth or (ii) a burst structure based on the ranging accuracy. The access point also determines a location of the device based on the FTM exchange using the at least one of (i) the bandwidth or (ii) the burst structure.

### Example Embodiments

The present disclosure describes a wireless network (e.g., WiFi network) that uses artificial intelligence to set the ranging parameters for FTM exchanges. When a device in the network communicates, to an access point, a request to perform FTM exchanges, the access point applies a machine learning model to radio frequency (RF) parameters related to the request to predict ranging accuracies for the device for different FTM ranging parameters (e.g., bandwidths and/or burst structures). The access point then selects a ranging accuracy (e.g., using an accuracy threshold) and uses the FTM ranging parameters for the selected ranging accuracy for the FTM exchanges with the device.

In certain embodiments, the wireless network provides several technical advantages. For example, the network may use artificial intelligence to balance the need for accuracy in FTM exchanges and the resulting congestion that negatively impacts other devices on the network. As another example, the network may use artificial intelligence to adapt the FTM ranging parameters to changes in the network (e.g., changes in the number of devices or changes to the locations of the devices).

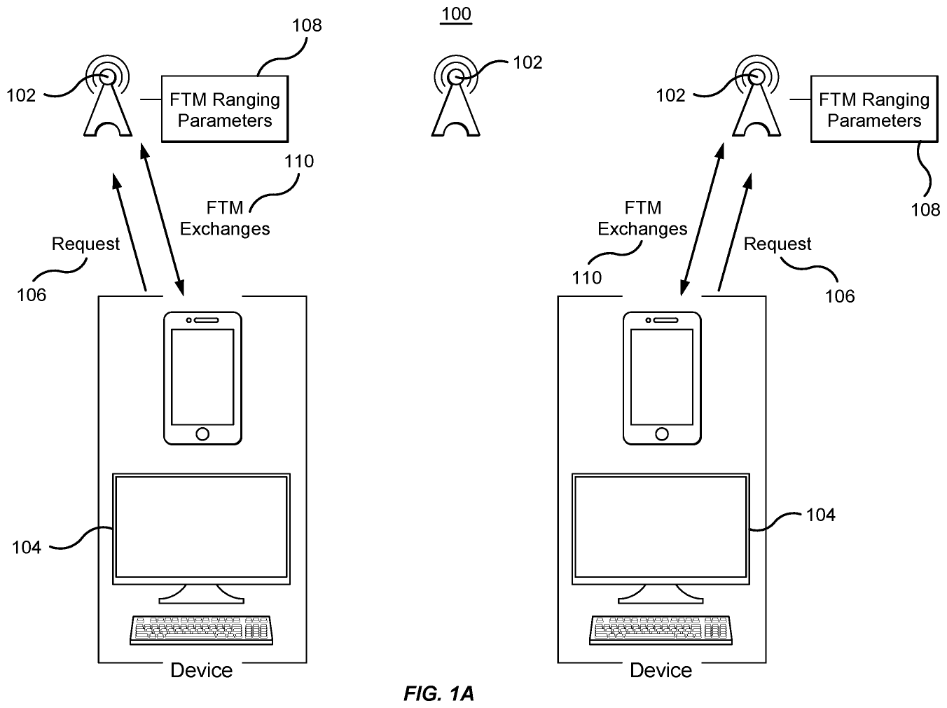

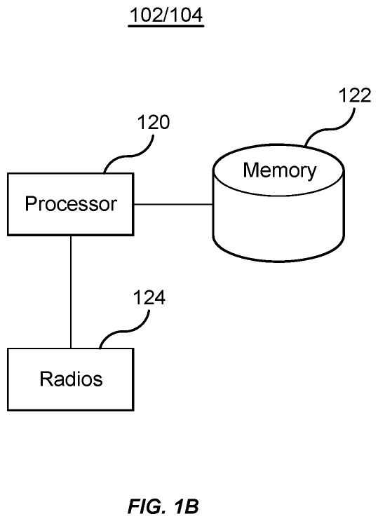

FIG. 1A illustrates an example system 100, which may be a wireless network (e.g., a WiFi network). As seen in FIG. 1A, the system 100 includes one or more access points 102 and one or more devices 104. Generally, the devices 104 connect to an access point 102. The access point 102 provides network coverage for the system 100. The access point 102 communicates messages to the devices 104 and directs messages from the devices 104 towards their destination.

The access point 102 facilitates wireless communication (e.g., WiFi communication) in the system 100. One or more devices 104 may connect to the access point 102. The access point 102 may then facilitate wireless communication for the connected devices 104. For example, the access point 102 may transmit messages to a connected device 104. As another example, the access point 102 may receive messages transmitted by the device 104. The access point 102 may then direct that message towards its intended destination.

The device 104 may be any suitable device that wirelessly connects to the access point 102. As an example and not by way of limitation, the device 104 may be a computer, a laptop, a wireless or cellular telephone, an electronic notebook, a personal digital assistant, a tablet, or any other device capable of receiving, processing, storing, or communicating information with other components of the system 100. The device 104 may be a wearable device such as a virtual reality or augmented reality headset, a smart watch, or smart glasses. The device 104 may also include a user interface, such as a display, a microphone, keypad, or other appropriate terminal equipment usable by the user. The device 104 may include a hardware processor, memory, or circuitry configured to perform any of the functions or actions of the device 104 described herein. For example, a software application designed using software code may be stored in the memory and executed by the processor to perform the functions of the device 104.

The access points 102 may perform FTM exchanges with the devices 104 to determine the locations of the devices 104 in the system 100. Generally, there is a tradeoff between the accuracy of the determined locations and the congestion on the network caused by the FTM exchanges. For example, the more FTM exchanges that the devices 104 have with the access points 102, the more accurate the determined locations and the higher the congestion. The fewer FTM exchanges that the devices 104 have with the access points 102, the less accurate the determined locations and the lower the congestion.

The access points 102 use artificial intelligence to set ranging parameters for FTM exchanges with the devices 104 in the system 100. In this manner, the access points 102 may balance the congestion caused by FTM exchanges with the need for increasing accuracy. Generally, the devices 104 communicate requests 106 to the access points 102 to request FTM exchanges. The access points 102 then use artificial intelligence to determine FTM ranging parameters 108 for the FTM exchanges. For example, the access points 102 may apply machine learning models to RF parameters for the request 106 to predict ranging accuracies for different FTM ranging parameters 108. The access points 102 then select the FTM ranging parameters 108 for desired ranging accuracies and apply the selected FTM ranging parameters 108 to FTM exchanges with the devices 104. The access points 102 and the devices 104 then perform FTM exchanges 110 using the FTM ranging parameters 108, which may reduce congestion relative to existing networks while providing a desired or sufficient level of ranging accuracy for the devices 104.

FIG. 1B illustrates an example access point 102 or device 104 in the system 100 of FIG. 1A. As seen in FIG. 1B, the access point 102 or device 104 includes a processor 120, a memory 122, and one or more radios 124.

The processor 120 is any electronic circuitry, including, but not limited to one or a combination of microprocessors, microcontrollers, application specific integrated circuits (ASIC), application specific instruction set processor (ASIP), and/or state machines, that communicatively couples to the memory 122 and controls the operation of the access point 102 and/or device 104. The processor 120 may be 8-bit, 16-bit, 32-bit, 64-bit or of any other suitable architecture. The processor 120 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The processor 120 may include other hardware that operates software to control and process information. The processor 120 executes software stored on the memory 122 to perform any of the functions described herein. The processor 120 controls the operation and administration of the access point 102 and/or device 104 by processing information (e.g., information received from the memory 122 and radios 124). The processor 120 is not limited to a single processing device and may encompass multiple processing devices contained in the same device or computer or distributed across multiple devices or computers. The processor 120 is considered to perform a set of functions or actions if the multiple processing devices collectively perform the set of functions or actions, even if different processing devices perform different functions or actions in the set.

The memory 122 may store, either permanently or temporarily, data, operational software, or other information for the processor 120. The memory 122 may include any one or a combination of volatile or non-volatile local or remote devices suitable for storing information. For example, the memory 122 may include random access memory (RAM), read only memory (ROM), magnetic storage devices, optical storage devices, or any other suitable information storage device or a combination of these devices. The software represents any suitable set of instructions, logic, or code embodied in a computer-readable storage medium. For example, the software may be embodied in the memory 122, a disk, a CD, or a flash drive. In particular embodiments, the software may include an application executable by the processor 120 to perform one or more of the functions described herein. The memory 122 is not limited to a single memory and may encompass multiple memories contained in the same device or computer or distributed across multiple devices or computers. The memory 122 is considered to store a set of data, operational software, or information if the multiple memories collectively store the set of data, operational software, or information, even if different memories store different portions of the data, operational software, or information in the set.

The radios 124 may communicate messages or information using different communication technologies. For example, the access point 102 and/or device 104 may use one or more of the radios 124 for WiFi communications. The access point 102 and/or device 104 may use one or more of the radios 124 to transmit messages and one or more of the radios 124 to receive messages. The access point 102 and/or device 104 may include any number of radios 124 to communicate using any number of communication technologies.

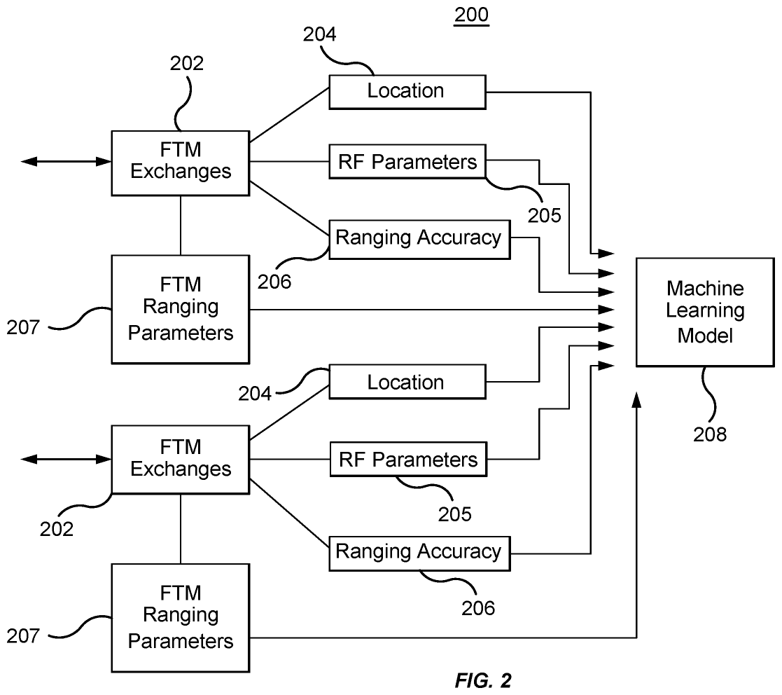

FIG. 2 illustrates an example operation 200 performed by the system 100 of FIG. 1A. Generally, an access point 102 performs the operation 200. By performing the operation 200, the access point 102 trains a machine learning model to predict FTM ranging accuracies.

The access point 102 begins by performing one or more FTM exchanges 202 with one or more devices. These devices may be referred to as training devices. The locations of the training devices may be known. By performing the FTM exchanges 202, the access point 102 may determine locations 204 of the training devices. Any type of FTM exchange may be used (e.g., 802.11mc, 802.11az, trigger-based, or non-trigger-based).

When performing the FTM exchanges 202, the access point 102 may also determine RF parameters 205 related to the FTM exchanges 202. For example, the access point 102 may determine certain parameters (e.g., channel, bandwidth, channel use, received signal strength indicators (RSSIs), signal-to-noise ratios (SNRs), and/or channel state information (CSI)). These RF parameters 205 may indicate certain characteristics of the network or communication medium between the access point 102 and the training devices.

The access point 102 then determines ranging accuracies 206 for the FTM exchanges 202. The access point 102 may determine the ranging accuracies 206 by comparing the determined locations 204 with the known locations of the training devices. The differences between the determined locations 204 and the known locations may indicate the ranging accuracies 206.

The access point 102 trains a machine learning model 208 using the locations 204, the RF parameters 205, and/or the ranging accuracies 206. In some embodiments, the access point 102 may also train the machine learning model 208 using other information, such as whether the FTM exchanges 202 were trigger-based and/or the timestamps of the FTM exchanges 202. By performing multiple FTM exchanges 202 to determine multiple sets of locations 204, RF parameters 205, and ranging accuracies 206, the access point 102 may provide multiple datasets to train the machine learning model 208. When the machine learning model 208 is trained with the dataset, the machine learning model 208 may learn to predict ranging accuracies based on provided RF parameters 205. The access point 102 may apply the trained machine learning model 208 to predict ranging accuracies when RF parameters have been determined.

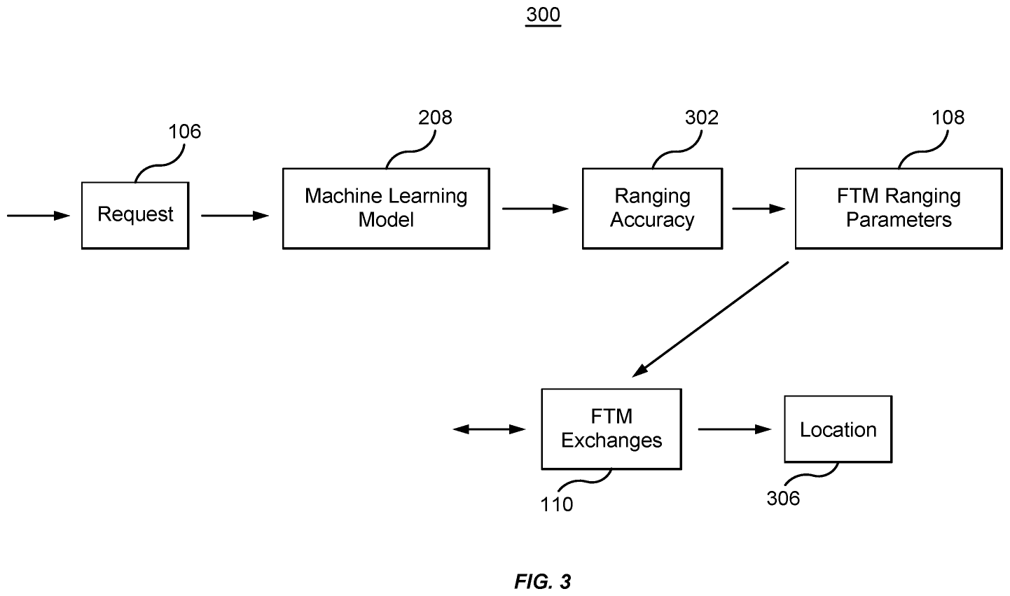

FIG. 3 illustrates an example operation 300 performed by the system 100 of FIG. 1A. Generally, an access point 102 performs the operation 300. By performing the operation 300, the access point 102 uses artificial intelligence to determine ranging parameters for FTM exchanges.

The access point 102 receives the request 106 from a device 104. The request 106 may request FTM exchanges between the access point 102 and the device 104. When the access point 102 receives the request 106, the access point 102 may use artificial intelligence to determine ranging parameters for the requested FTM exchanges.

The access point 102 may determine RF parameters related to the request 106. For example, the device 104 may measure certain characteristics or qualities of the communication medium between the access point 102 and the device 104 used to communicate the request 106. The device 104 may then communicate these measured characteristics or qualities to the access point 102 as the RF parameters. The access point 102 may then apply the machine learning model 208 to the RF parameters to determine ranging accuracies for different sets of FTM ranging parameters for the FTM exchanges. The access point 102 may select a desired ranging accuracy 302 and the FTM ranging parameters 108 for the selected ranging accuracy 302.

The access point 102 then performs the FTM exchanges 110 with the device 104 using the determined FTM ranging parameters 108. By performing the FTM exchanges 110, the access point 102 may determine a location 306 of the device 104. Additionally, by using the FTM ranging parameters 108 for the FTM exchanges 110, the access point 102 may limit congestion on the network while providing a desired ranging accuracy 302 for the FTM exchanges 110.

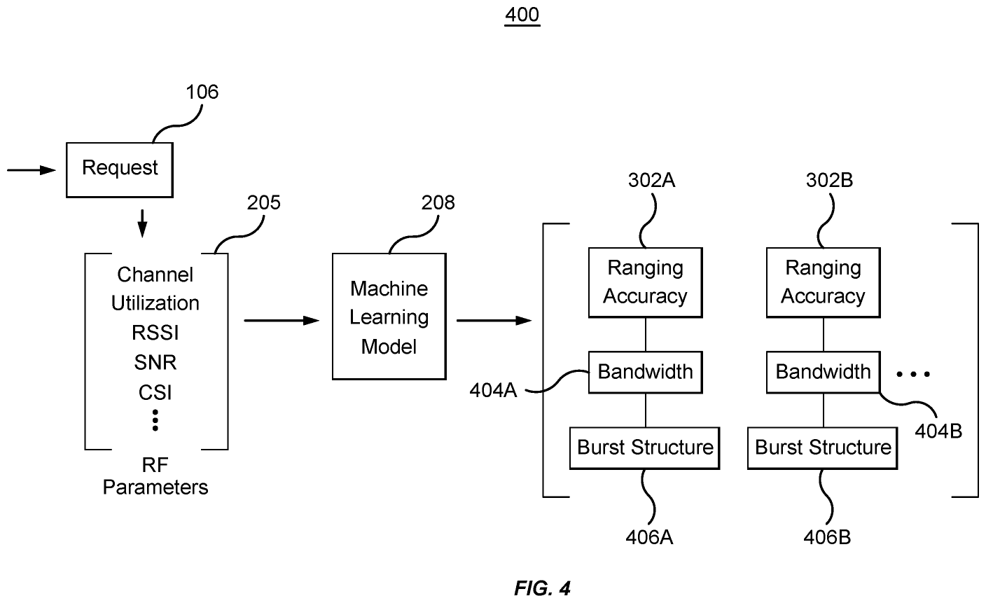

FIG. 4 illustrates an example operation 400 performed by the system 100 of FIG. 1A. Generally, the access point 102 performs the operation 400. By performing the operation 400, the access point 102 uses artificial intelligence to determine multiple sets of ranging accuracies 302 and FTM ranging parameters 108.

The access point 102 begins by receiving the request 106 from a device 104 in the system 100. The request 106 may request that FTM exchanges be performed between the access point 102 and the device 104. The access point 102 may determine RF parameters 205 for the request 106. For example, the device 104 may measure certain characteristics or qualities of the communication medium between the access point 102 and the device 104 used to communicate the request 106, and the device 104 may communicate these measured characteristics or qualities to the access point 102 as the RF parameters 205. In the example of FIG. 4, the access point 102 determines the channel utilization, RSSI, SNR, and/or CSI as the RF parameters 205.

The access point 102 then applies the machine learning model 208 to the RF parameters 205 to determine multiple sets of ranging accuracies 302 and FTM ranging parameters. As discussed previously, the access point 102 may have trained the machine learning model 208 to predict ranging accuracies and ranging parameters based on provided RF parameters. Thus, by applying the machine learning model 208 to the RF parameters 205, the machine learning model 208 may predict multiple sets of ranging accuracies 302 and FTM ranging parameters 108. Each set may indicate the FTM ranging parameters 108 and the ranging accuracy 302 provided by the FTM ranging parameters 108.

As seen in FIG. 4, the machine learning model 208 predicts multiple sets of ranging accuracies 302, including the ranging accuracies 302A and 302B. The ranging accuracies 302A and 302B may be provided if certain FTM ranging parameters 108 are set. In the example of FIG. 4, the FTM ranging parameters 108 include bandwidths 404 and burst structures 406. The machine learning model 208 predicts that the ranging accuracy 302A may be provided if the access point 102 sets the bandwidth as the bandwidth 404A and the burst structure as the burst structure 406A. Additionally, the machine learning model 208 predicts that the ranging accuracy 302B may be provided if the access point 102 sets the bandwidth as the bandwidth 404B and the burst structure as the burst structure 406B. The access point 102 and/or the machine learning model 208 may predict any number of sets of ranging accuracies 302 and FTM ranging parameters 108.

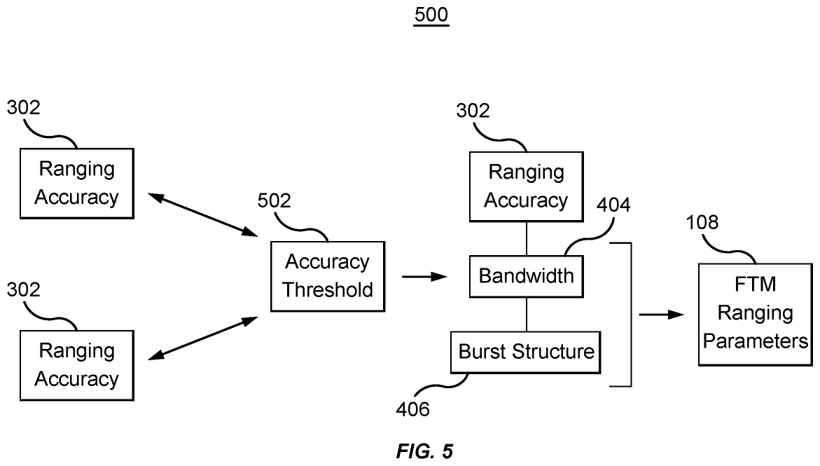

FIG. 5 illustrates an example operation 500 performed by the system 100 of FIG. 1A. Generally, the access point 102 performs the operation 500. By performing the operation 500, the access point 102 selects one of the sets of ranging accuracies 302 and FTM ranging parameters 108.

As seen in FIG. 5, the access point 102 has applied the machine learning model 208 to predict multiple ranging accuracies 302. The access point 102 compares the ranging accuracies 302 to an accuracy threshold 502. The accuracy threshold 502 may indicate a desired accuracy for the FTM exchanges or a minimum accuracy that the access point 102 should provide to the device 104 during the FTM exchanges.

By comparing the ranging accuracies 302 to the accuracy threshold 502, the access point 102 may select a ranging accuracy 302. For example, the access point 102 may select the ranging accuracy 302 that is closest to the accuracy threshold 502 and that exceeds the accuracy threshold 502. In this manner, the access point 102 selects the ranging accuracy 302 that both meets the accuracy threshold 502 but that does not so greatly exceed the accuracy threshold 502 so as to cause unwanted congestion on the network.

The access point 102 also selects the FTM ranging parameters 108 for the selected ranging accuracy 302. In the example of FIG. 5, the bandwidth 404 and the burst structure 406 for the selected ranging accuracy 302 are selected. The access point 102 may set the bandwidth 404 and the burst structure 406 as the FTM ranging parameters 108 for the FTM exchanges with the device 104.

In some embodiments, the access point 102 may select a ranging accuracy 302 that greatly exceeds the accuracy threshold 502 if the channel utilization is low. When the channel utilization is low, additional congestion on the channel may be more tolerable. Thus, the access point 102 may select a higher ranging accuracy 302 and FTM ranging parameters 108. In this manner, the access point 102 considers channel utilization when selecting the ranging accuracy 302.

In certain embodiments, the access point 102 may provide FTM ranging parameters 108 for different modes of FTM exchanges. For example, the access point 102 may provide the device 104 different sets of FTM ranging parameters 108 for different modes or types of FTM exchanges (e.g., 802.11mc, 802.11az, trigger-based, non-trigger-based, etc.). The device 104 may then implement the FTM ranging parameters 108 for the desired mode of FTM exchanges. In some instances, the device 104 may suggest a mode for the FTM exchanges, and the access point 102 provides the FTM ranging parameters 108 for the suggested mode.

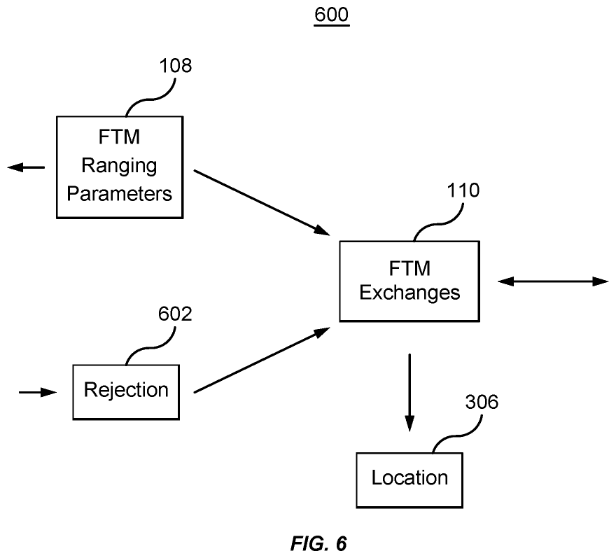

FIG. 6 illustrates an example operation 600 performed by the system 100 of FIG. 1A. Generally, the access point 102 performs the operation 600. By performing the operation 600, the access point 102 performs FTM exchanges 110 with a device 104.

The access point 102 communicates to the device 104 the FTM ranging parameters 108 that the access point 102 determined (e.g., the bandwidth and the burst structure). The device 104 may choose to accept or reject the FTM ranging parameters 108. If the device 104 accepts the FTM ranging parameters 108, the device 104 may communicate a confirmation to the access point 102. The access point 102 then performs the FTM exchanges 110 with the device 104 using the determined FTM ranging parameters 108. By performing the FTM exchanges 110, the access point 102 determines the location 306 of the device 104.

The device 104 may reject the FTM ranging parameters 108 communicated by the access point 102. The access point 102 may receive a rejection 602 from the device 104 of the FTM ranging parameters 108. The access point 102 may override the rejection 602 and perform the FTM exchanges 110 with the FTM ranging parameters 108. In some embodiments, the access point 102 may have a set rigidity value that governs how the access point 102 overrides the rejection. For example, the rigidity value may indicate by how much the access point 102 may adjust or change the FTM ranging parameters 108 when overriding the rejection 602. This adjustment or change may better accommodate the desires of the device 104.

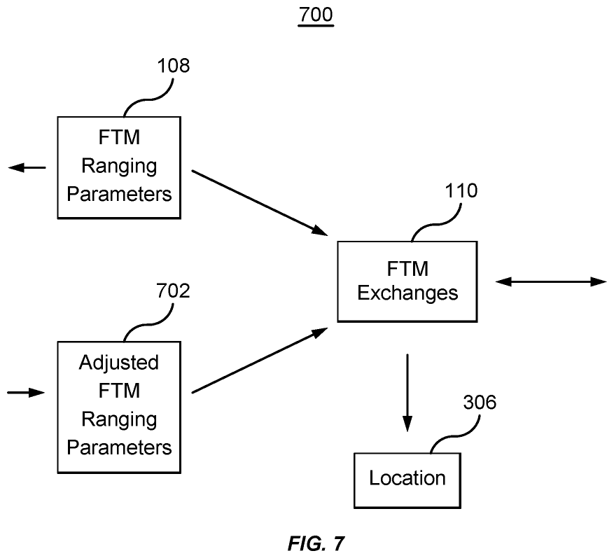

FIG. 7 illustrates an example operation 700 performed by the system 100 of FIG. 1A. Generally, the access point 102 performs the operation 700. By performing the operation 700, the access point 102 allows the device 104 to provide adjusted FTM ranging parameters for the FTM exchanges.

As discussed previously, in some instances, the device 104 may reject the FTM ranging parameters 108 provided by the access point 102. The device 104, however, may provide the access point 102 adjusted FTM ranging parameters 702 as part of rejecting the FTM ranging parameters 108. The rejection 602 may include the adjusted FTM ranging parameters 702. The access point 102 may accept or reject the adjusted FTM ranging parameters 702. If the access point 102 accepts the adjusted FTM ranging parameters 702, then the access point 102 replaces the FTM ranging parameters 108 with the adjusted FTM ranging parameters 702. The access point 102 then performs the FTM exchanges 110 using the adjusted FTM ranging parameters 702.

In some embodiments, the device 104 may provide a reason for rejecting the FTM ranging parameters 108 provided by the access point 102. For example, the device 104 may include a code in the rejection 602 that indicates the reason for rejecting the FTM ranging parameters 108. The reasons may include low confidence level, training sample too small, etc.

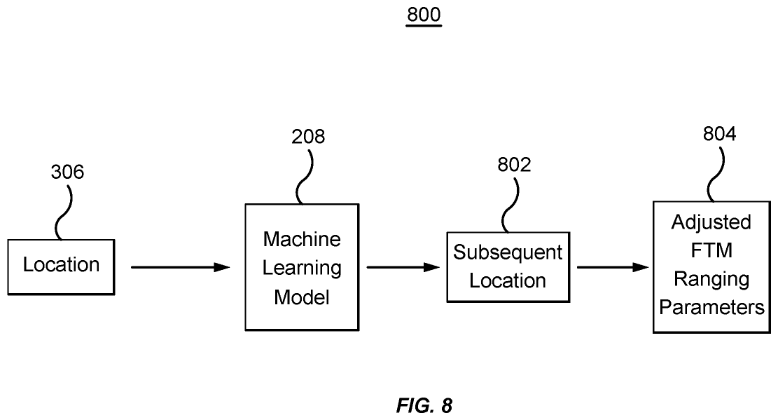

FIG. 8 illustrates an example operation 800 performed by the system 100 of FIG. 1A. Generally, the access point 102 performs the operation 800. By performing the operation 800, the access point 102 adjusts FTM ranging parameters as the device 104 moves in the system 100.

The access point 102 may begin by determining the location 306 of the device 104. For example, the access point 102 may have performed the FTM exchanges 110 with the device 104 to determine the location 306 of the device 104. The access point 102 may apply the machine learning model 208 to the location 306 to predict a subsequent location 802 for the device 104. For example, the access point 102 may have trained the machine learning model 208 to track the movement of the device 104 in the system 100. The access point 102 may determine patterns in the movement of the device 104 in the system 100 (e.g., using an extended Kalman filter and/or wavelets). When the access point 102 provides the machine learning model 208 the location 306 of the device 104, the machine learning model 208 may predict the movement of the device 104 and/or the subsequent location 802 of the device 104.

The access point 102 may then adjust the FTM ranging parameters to produce the adjusted FTM ranging parameters 804 for the subsequent location 802. In some embodiments, the access point 102 applies the machine learning model 208 to RF parameters for the subsequent location 802 to determine the adjusted FTM ranging parameters 804. After the device 104 moves to the subsequent location 802, the access point 102 may perform FTM exchanges with the device 104 using the adjusted FTM ranging parameters 804. In this manner, the access point 102 anticipates the movement of the device 104 and adjusts the FTM ranging parameters proactively.

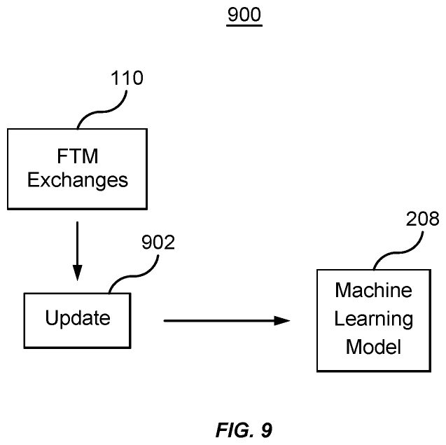

FIG. 9 illustrates an example operation 900 performed by the system 100 of FIG. 1A. Generally, the access point 102 performs the operation 900. By performing the operation 900, the access point 102 updates the machine learning model 208.

As the access point 102 performs the FTM exchanges 110 with the device 104, the access point 102 may track the status of the FTM exchanges 110. For example, the access point 102 may track RF parameters and/or ranging accuracies for the FTM exchanges 110. The access point 102 may provide an update 902 for the machine learning model 208 based on the information that the access point 102 tracks during the FTM exchanges 110. For example, the access point 102 may provide the information to the machine learning model 208 to update or train the machine learning model 208. In this manner, the access point 102 may improve the prediction accuracy of the machine learning model 208 with recent information gleaned from FTM exchanges 110. For example, by updating the machine learning model 208, the access point 102 may improve subsequence predictions of ranging accuracy using the machine learning model 208.

In some embodiments, the access point 102 and/or the machine learning model 208 observes the CSI of the FTM exchanges 110. The access point 102 and/or the machine learning model 208 builds a differential coefficient that measures the stability of the channel. The coefficient may then be used to recommend an exchange interval to the device 104. For example, a more stable channel may require less frequent measurements. Thus, the access point 102 and/or the machine learning model 208 may recommend a lower or higher exchange interval according to the stability of the channel.

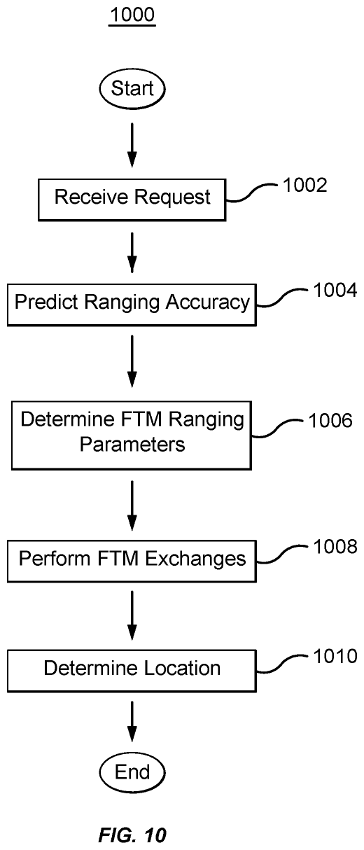

FIG. 10 is a flowchart of an example method 1000 performed by the system 100 of FIG. 1A. In particular embodiments, the access point 102 performs the method 1000. By performing the method 1000, the access point 102 uses artificial intelligence to determine FTM ranging parameters 108 for FTM exchanges 110.

In block 1002, the access point 102 receives the request 106 from the device 104 to perform FTM exchanges with the device 104. In block 1004, the access point 102 predicts the ranging accuracy 302. For example, the access point 102 may determine RF parameters 205 related to the communication of the request 106. The access point 102 may then apply the machine learning model 208 to the RF parameters 205 to determine one or more ranging accuracies 302 for the FTM exchanges 110 with the device 104. The access point 102 may compare the ranging accuracies 302 with an accuracy threshold 502 to select a ranging accuracy 302. In some embodiments, the access point 102 may select the ranging accuracy 302 that is both closest to the accuracy threshold 502 and that exceeds the accuracy threshold 502.

In block 1006, the access point 102 determines FTM ranging parameters 108 for the FTM exchanges 110. When the access point 102 applied the machine learning model 208 to the RF parameters 205, the machine learning model 208 may determine FTM ranging parameters 108 for each determined ranging accuracy 302. In some embodiments, these FTM ranging parameters 108 include bandwidths 404 and/or burst structures 406 to be used to achieve the determined ranging accuracies 302. The access point 102 may select the FTM ranging parameters 108 for the selected ranging accuracy 302. In block 1008, the access point 102 performs the FTM exchanges 110 using the determined FTM ranging parameters 108. In block 1010, the access pint 102 determines location 306 for the device 104 using information determined from the FTM exchanges 110. In certain embodiments, by performing the FTM exchanges 110 using the determined FTM ranging parameters 108, the access point 102 provides a sufficiently high ranging accuracy 302 while limiting the congestion on the network caused by the FTM exchanges 110. The access point 102 effectively balances the need for ranging accuracy with the congestion caused by FTM exchanges.

In summary, the access point 102 uses artificial intelligence to set the ranging parameters 108 for FTM exchanges 110. When a device 104 in the network communicates a request to perform FTM exchanges, the access point 102 applies the machine learning model 208 to RF parameters related to the request to predict ranging accuracies for different FTM ranging parameters (e.g., bandwidths and/or burst structures). The access point 102 then selects a ranging accuracy (e.g., using an accuracy threshold) and uses the FTM ranging parameters for the selected ranging accuracy for the FTM exchanges 110 with the device 104.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. An apparatus comprising:
one or more memories; and
one or more processors communicatively coupled to the one or more memories, a combination of the one or more processors configured to:
predict a ranging accuracy for a device by applying a machine learning model to a request from the device to perform a fine timing measurement (FTM) exchange;
determine, based on the ranging accuracy, an FTM ranging parameter for the FTM exchange; and
perform the FTM exchange based on the FTM ranging parameter to determine a location of the device.

2. The apparatus of claim 1, wherein the FTM ranging parameter indicates at least one of (i) a bandwidth to be used for the FTM exchange or (ii) a burst structure for the FTM exchange.

3. The apparatus of claim 1, wherein determining the FTM ranging parameter is based on the ranging accuracy meeting an accuracy threshold.

4. The apparatus of claim 1, wherein the combination of the one or more processors is further configured to update the machine learning model using information from the FTM exchange.

5. The apparatus of claim 1, wherein the combination of the one or more processors is further configured to:
communicate the FTM ranging parameter to the device;
receive, from the device, a rejection of the FTM ranging parameter; and
override the rejection from the device.

6. The apparatus of claim 1, wherein the combination of the one or more processors is further configured to:
communicate the FTM ranging parameter to the device;
receive, from the device, an adjusted FTM ranging parameter; and
replace the FTM ranging parameter with the adjusted FTM ranging parameter from the device.

7. The apparatus of claim 1, wherein the combination of the one or more processors is further configured to:
predict, using the machine learning model and based on the location of the device, a subsequent location of the device; and
adjust the FTM ranging parameter based on the subsequent location of the device.

8. The apparatus of claim 1, wherein the combination of the one or more processors is further configured to:
determine, based on a FTM exchange with a training device, (i) a location of the training device and (ii) a ranging accuracy of the FTM exchange with the training device; and
train, based on the location of the training device and the ranging accuracy, the machine learning model.

9. A method comprising:
predicting a ranging accuracy for a device by applying a machine learning model to a request from the device to perform an FTM exchange;
determining, based on the ranging accuracy, an FTM ranging parameter for the FTM exchange; and
perform the FTM exchange based on the FTM ranging parameter to determine a location of the device.

10. The method of claim 9, wherein the FTM ranging parameter indicates at least one of (i) a bandwidth to be used for the FTM exchange or (ii) a burst structure for the FTM exchange.

11. The method of claim 9, wherein determining the FTM ranging parameter is based on the ranging accuracy meeting an accuracy threshold.

12. The method of claim 9, further comprising updating the machine learning model using information from the FTM exchange.

13. The method of claim 9, further comprising:
communicating the FTM ranging parameter to the device;
receiving, from the device, a rejection of the FTM ranging parameter; and
overriding the rejection from the device.

14. The method of claim 9, further comprising:
communicating the FTM ranging parameter to the device;
receiving, from the device, an adjusted FTM ranging parameter; and
replacing the FTM ranging parameter with the adjusted FTM ranging parameter from the device.

15. The method of claim 9, further comprising:
predicting, using the machine learning model and based on the location of the device, a subsequent location of the device; and
adjusting the FTM ranging parameter based on the subsequent location of the device.

16. The method of claim 9, further comprising:
determining, based on a FTM exchange with a training device, (i) a location of the training device and (ii) a ranging accuracy of the FTM exchange with the training device; and
training, based on the location of the training device and the ranging accuracy, the machine learning model.

17. A system comprising:
a device configured to communicate a request to perform an FTM exchange; and
an access point configured to:
apply a machine learning model to the request from the device to predict a ranging accuracy for the device;
determine at least one of (i) a bandwidth or (ii) a burst structure based on the ranging accuracy; and
determine a location of the device based on the FTM exchange using the at least one of (i) the bandwidth or (ii) the burst structure.

18. The system of claim 17, wherein determining the at least one of (i) the bandwidth or (ii) the burst structure is based on the ranging accuracy meeting an accuracy threshold.

19. The system of claim 17, wherein the access point is further configured to update the machine learning model using information from the FTM exchange.

20. The system of claim 17, wherein the access point is further configured to:
communicate the at least one of (i) the bandwidth or (ii) the burst structure to the device;
receive, from the device, a rejection of the at least one of (i) the bandwidth or (ii) the burst structure; and
override the rejection from the device.
